(19) United States
(12) Patent Application Publication
(10) Pub. No.: US 2005/0010017 A1
(43) Pub. Date: Jan. 13, 2005

(54) Addition of UV inhibitors to pet process for maximum yield

(76) Inventors: Dale Milton Blakely, Kingsport, TN (US); Frederick Leslie Colhoun, Kingsport, TN (US)

Correspondence Address: Dennis V. Carmen;Eastman Chemical Company, P.O. Box 511, Kingsport, TN, 37662-5075, US

(21) Appl. No.: 10/618,274

(22) Filed: Jul. 11, 2003

(51) Int. Cl. C08G 63/78; C08G 63/87; C08G 63/54; C08G 63/00; C08G 63/82

(52) U.S. Cl. 528/275; 528/281; 528/308; 528/304

(57) ABSTRACT

The present invention is a method of efficiently incorporating a UV inhibitor into a polyester resin. The method of the invention comprises forming a reaction mixture comprising a diol, a diacid component selected from the group consisting of dicarboxylic acids, dicarboxylic acid derivatives, and mixtures thereof, an antimony containing compound, a phosphorus containing compound, a metal containing compound selected, and a UV inhibitor. The reaction mixture is polymerized in a polycondensaton reaction system. In another embodiment of the present invention, the UV inhibitor is added while the reaction products from one reactor are transferred to the next reactor in the polycondensation reaction system.

### BACKGROUND OF THE INVENTION

1. Field of the Invention

In at least one aspect, the present invention relates to methods of efficiently incorporating UV inhibitors into polyester composition and to polyester compositions made by said methods.

2. Background Art

Polyester is a widely used polymeric resin used in a number of packaging and fiber based applications. Poly(ethylene terephthalate) (“PET”) or a modified PET is the polymer of choice for making beverage and food containers such as plastic bottles and jars used for carbonated beverages, water, juices, foods, detergents, cosmetics, and other products.

In the typical polyester forming polycondensation reaction, a diol such as ethylene glycol is reacted with a dicarboxylic acid or a dicarboxylic acid ester. The reaction is accelerated by the addition of a suitable reaction catalyst. Since the product of these condensation reaction tends to be reversible and in order to increase the molecular weight of the polyesters, this reaction is often carried out in a multi-chamber polycondensation reaction system having several reaction chambers operating in series. Typically, the diol and the dicarboxylic acid component are introduced in the first reactor at a relatively high pressure. After polymerizing at an elevated temperature the resulting polymer is then transferred to the second reaction chamber which is operated at a lower pressure than the first chamber. The polymer continues to grow in this second chamber with volatile compounds being removed. This process is repeated successively for each reactor, each of which are operated at lower and lower pressures. The result of this step wise condensation is the formation of polyester with high molecular weight and higher inherent viscosity.

During the polycondensation process, various additives such as colorants and UV inhibitors may be added. UV inhibitors are a particularly important additive, both for imparting stability to the polyesters and to protect those products packaged in PET containers from degradation induced by exposure to UV light. U.S. Pat. No. 4,617,374 (the '374 patent) discloses the use of certain UV-absorbing methine compounds that may be incorporated in a polyester or a polycarbonate during polycondensation. These compounds enhance ultraviolet or visible light absorption with a maximum absorbance within the range of from about 320 nm to about 380 nm. Functionally, these compounds contain an acid or ester group which condenses onto the polymer chain as a terminator. Moreover, the UV inhibitors of the '374 patent have been found to be useful in the preparation of polyesters such as poly(ethylene terephthalate) and copolymers of poly(ethylene terephthalate) and poly(1,4-cyclohexylenedimethylene terephthalate). It has been observed, however, that some UV inhibitors are somewhat volatile causing the yield of these UV inhibitors in the formed polyester to be somewhat less than 100% (values of 80% to 85% are typical). Moreover, these compounds may plug the equipment by condensing in the process lines. The loss of UV inhibitor results in added costs for the polyester formation because of the down time needed to clean process lines and because of the relatively high cost of these compounds.

Accordingly, there is a need for improved methods of incorporating UV inhibitors into polyester compositions made by the melt phase polycondensation method, and/or improved polyester compositions containing UV inhibitors.

### SUMMARY OF THE INVENTION

The present invention overcomes the problems of the prior art by providing a method of incorporating a UV inhibitor into a polyester resin.

In one embodiment, a method comprises forming a reaction mixture substantially free of a titanium containing ester exchange catalyst compound and comprising a diol, a diacid component selected from the group consisting of dicarboxylic acids, dicarboxylic acid derivatives, and mixtures thereof, an antimony containing compound in an amount of less than 0.1% of the total weight of the reaction mixture, a phosphorus containing compound present in an amount of less than about 0.1% of the total weight of the reaction mixture, a metal containing compound selected from the group consisting of zinc containing compounds, manganese containing compounds, present in an amount from about 10 ppm to about 300 ppm, and a UV inhibitor. The antimony containing compound, the phosphorus containing compound, and the metal-containing compound comprise the catalyst system used to promote the condensation polymerization that occurs in the method of the invention. The reaction mixture is then polymerized in a polycondensaton reaction system in the absence of the titanium ester exchange catalyst compound. The polycondensation reaction system is characterized by having a first reaction chamber, a last reaction chamber, and optionallyone or more intermediate reaction chambers between the first reaction chamber and the last reaction chamber. The reaction system is operated in series such that the reaction mixture is progressively polymerized in the first reaction chamber, the one or more intermediate reactions, and the last reaction chamber. Accordingly, as the reaction mixture proceeds through the series of reaction chambers, polymerization occurs and a polyester is formed by the condensation reaction of the diol and the diacid component. Moreover, volatile compounds are removed in each reaction chamber and the average molecular weight of the polyester increase from reactor to reactor by the decreasing reaction pressures of the successive reaction chambers.

In another embodiment of the present invention, a method of incorporating a UV inhibitor in a polyester composition is provided. The method of this embodiment comprises. a) forming a reaction mixture comprising:
a diol,
a diacid component selected from the group consisting of dicarboxylic acids, dicarboxylic acid derivatives, and mixtures thereof in a polycondensation reaction system comprising a series of reaction chambers designatable as reaction chamber RCⁱ having a first reaction chamber designatable as reaction chamber RC^{l}, a last reaction chamber designatable as reaction chamber RC^{k}, and one or more intermediate reaction chambers
b) successively polymerizing the reaction mixture in the multichamber polymerization system wherein the reaction system is operated in series such that a reaction product designatable as product P from reaction chamber Rⁱ is transportable to reaction chamber RCⁱ⁺¹ by a conduit designatable as conduit Cⁱ connecting reaction chamber RCⁱ to a reaction chamber RCⁱ⁺¹; and
c) adding the UV inhibitor to reaction product Pⁱ as it is transported from reaction chamber RCⁱ to reaction chamber RCⁱ⁺¹, wherein i and k are integer and k is the total number of reaction chambers.

In yet another embodiment of the present invention, a titanium metal free polyester composition is provided. The titanium free polyester composition of this embodiment comprises a diol residue, as diacid residue, a UV inhibitor residue, antimony atoms, phosphorus atoms, and metal atoms selected from the group consisting of zinc, manganese, and mixtures thereof. The antimony, phosphorus, and metal atoms represent the residue of the catalyst system used to promote the condensation polymerization that forms the polyester composition.

### DETAILED DESCRIPTION OF THE PREFERRED EMBODIMENT(S)

Reference will now be made in detail to presently preferred compositions or embodiments and methods of the invention, which constitute the best modes of practicing the invention presently known to the inventors.

The term “residue” as used herein, refers to the portion of a compound that is incorporated into a polyester composition after the polycondensation.

In an embodiment of the present invention, a method of incorporating a UV inhibitor into a polyester resin is provided. The method of this embodiment comprises forming a reaction mixture substantially free of a titanium containing ester exchange catalyst compound and comprising a diol, a diacid component selected from the group consisting of dicarboxylic acids, dicarboxylic acid derivatives, and mixtures thereof, an antimony containing compound in an amount of less than 0.1% of the total weight of the reaction mixture, a phosphorus containing compound present in an amount of less than about 0.1% of the total weight of the reaction mixture, a metal containing compound selected from the group consisting of zinc containing compounds, manganese containing compounds, present in an amount from about 10 ppm to about 300 ppm, and a UV inhibitor. We have found that polyester compositions can be made from reaction mixtures substantially free of titanium containing ester exchange catalysts with high yields of UV inhibitors. While the mechanism to explain this phenomena is not fully understood, it is believed that the presence of titanium containing ester exchange compounds have such high conversion activity that the catalyst may also contribute to reactions which degrade some UV inhibitors, prevent the UV inhibitors from absorbing, dissolving, or otherwise tying into the polyester polymer, or both. By the phrase “in the absence of” does not preclude the presence of trace amounts of titanium containing compounds, and in this regard, the presence of greater than 0 to 5 ppm of titanium metal is considered a trace amount which can be found in the polyester composition made by what is considered to be a process conducted in the absence of a titanium containing ester exchange catalyst. Preferably, the process is conducted using compounds containing 2 ppm or less of titanium metal, and more preferably 0.0 ppm of titanium metal containing compounds are used in the process of the invention.

In this embodiment, thereaction mixture is then polymerized in a multichamber polymerization system. The polycondensation reaction system is characterized by having a first reaction chamber, a last reaction chamber, and one or more intermediate reaction chambers between the first reaction chamber and the last reaction chambers. The reaction system is operated in series such that the reaction mixture is progressively polymerized in the first reaction chamber, the one or more intermediate reactions, and the last reaction chamber. The UV inhibitor may be added at any point in the melt phase. The polyester removed from the last reaction chamber has an inherent viscosity from about 0.2 to about 0.75 dL/g. Finally, the reaction mixture is further characterized by having from 0.0 to about 5 ppm titanium containing atoms.

The UV inhibitors used in the method of this embodiment are disclosed in U.S. Pat. No. 4,617,374 the entire disclosure of which is hereby incorporated by reference. The UV inhibitors have formula I: 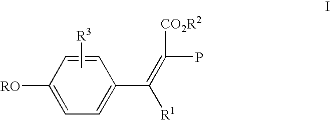
wherein,
R is hydrogen, alkyl, substituted alkyl, aryl, substituted aryl, cycloalkyl, substituted cycloalkyl, or alkenyl;
R¹ is hydrogen, or alkyl, aryl, or cycloalkyl, all of which may be substituted;
R² is hydrogen or any radical which does not interfere with condensation with the polyester;
R³ is hydrogen or 1-3 substituents selected from alkyl, substituted alkyl, alkoxy, substituted alkoxy, and halogen;
P is cyano or a group selected from carbamyl, aryl, alkylsulfonyl, arylsulfonyl, heterocyclic, alkanoyl or aroyl, all of which groups may be substituted. More preferably, and R is selected from hydrogen; cycloalkyl; cycloalkyl substituted with one or two of alkyl, alkoxy or halogen; phenyl; phenyl substituted with 1-3 of alkyl, alkoxy, halogen, alkanoylamino, or cyano; straight or branched lower alkenyl; straight or branched alkyl and such alkyl substituted with 1-3 of the following: halogen; cyano; succinimido; glutarimido; phthalimido; phthalimidino; 2-pyrrolidono; cyclohexyl; phenyl; phenyl substituted with alkyl, alkoxy, halogen, cyano, or alkylsulfamoyl; vinylsulfonyl; acrylamido; sulfamyl; benzoylsulfonicimido; alkylsulfonamido; phenylsulfonamido; alkenylcarbonylamino; groups of the formula 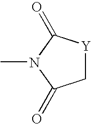
   wherein Y is —NH—, 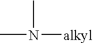
   —O—, —S—, or —CH₂O—; —S—R⁴; SO₂ CH₂ CH₂SR⁴; wherein R⁴ is alkyl, phenyl, phenyl substituted with halogen, alkyl, alkoxy, alkanoylamino, or cyano, pyridyl, pyrimidinyl, benzoxazolyl, benzimidazolyl, benzothiazolyl, or a radical of the formulae 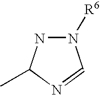
   —NHXR⁵; —CONR⁶R⁶; and —SO₂NR⁶R⁶; wherein R⁶ is selected from H, aryl, alkyl, and alkyl substituted with halogen, phenoxy, aryl, —CN, cycloalkyl, alkylsulfonyl, alkylthio, or alkoxy; X is —CO—, —COO—, or —SO₂—; R⁵ is selected from alkyl and alkyl substituted with halogen, phenoxy, aryl, cyano, cycloalkyl, alkylsulfonyl, alkylthio, and alkoxy; and when X is —CO—, R⁵ also can be hydrogen, amino, alkenyl, alkylamino, dialkylamino, arylamino, aryl, or furyl; alkoxy; alkoxy substituted with cyano or alkoxy; phenoxy; or phenoxy substituted with 1-3 of alkyl, alkoxy, or halogen; and P is cyano, carbamyl, N-alkylcarbamyl, N-alkyl-N-arylcarbamyl, N,N-dialkylcarbamyl, N,N-alkyl-arylcarbamyl, N-arylcarbamyl, N-cyclohexylcarbamyl, aryl, 2-benzoxazolyl, 2-benzothiazolyl, 2-benzimidazolyl, 1,3,4-thiadiazol-2-yl, 1,3,4-oxadiazol-2-yl, alkylsulfonyl, arylsulfonyl, alkanoyl or aroyl. Most preferably, R¹ is hydrogen and P is cyano. The most preferred UV inhibitor is described by formula II:

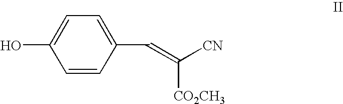

The polymerization is carried out such that the reaction pressure in the first chamber is from about 20 to 50 psi and the reaction pressure in the last reaction chamber is from about 0.1 mm Hg to about 2 mm Hg. The pressure in the intermediate reactor successively dropped with the reaction pressure in each of the one or more intermediate reactor being between 50 psi and 0.1 mm Hg. The reaction temperature in each reaction chamber is from about 200° C. to about 300° C.

The reaction mixture used in the method of the invention includes a diol component. Preferably, the diol component is a glycol. Suitable diols include, for example, diols selected from the group consisting of ethylene glycol, 1,4-cyclohexanedimethanol, 1,2-propanediol, 1,3-propanediol, 1,4-butanediol, 2,2-dimethyl-1,3-propanediol, 1,6-hexanediol, 1,2-cyclohexanediol, 1,4-cyclohexanediol, 1,2-cyclohexanedimethanol, 1,3-cyclohexanedimethanol, X,8-bis(hydroxymethyl)tricyclo-[5.2.1.0]-decane wherein X represents 3, 4, or 5, and diols containing one or more oxygen atoms in the chain, e.g., diethylene glycol, triethylene glycol, dipropylene glycol, tripropylene glycol and the like containing mixtures of both forms. More preferably, the diol comprises a component selected from the group consisting of ethylene glycol, diethylene glycol, 1,4-cyclohexanedimethanol, or mixtures thereof. In many cases, the diol may comprise a major amount of ethylene glycol and modifying amounts cyclohexanedimethanol and/or diethylene glycol. The reaction mixture also includes a diacid component selected from the group consisting of aliphatic, alicyclic, or aromatic dicarboxylic acids and esters of such dicarboxylic acids. Suitable diacid components are selected from the group consisting of terephthalic acid, naphthalene dicarboxylic acid, isophthalic acid, 1,4-cyclohexanedicarboxylic acid, 1,3-cyclohexanedicarboxylic acid, succinic acid, glutaric acid, adipic acid, sebacic acid, 1,12-dodecanedioic acid, and the like; and esters of these dicarboxylic acids. In the polymer preparation, it is often preferable to use a functional acid derivative thereof such as the dimethyl, diethyl, or dipropyl ester of the dicarboxylic acid. The anhydrides of these acids also can be employed. Preferably, the diacid component comprises a dicarboxylic acid ester. More preferably, the diacid component is terephthalic acid or dimethyl terephthalate. Most preferably, the diacid component comprises dimethyl terephthalate. The molar ratio of the diol component to the diacid component is from about 0.5 to about 4. More preferably, the molar ratio of the diol component to the diacid component is from about 1 to about 3. Most preferably, the ratio of the diol to the diacid component is about 2.

The reaction mixture further comprises a component containing a metal selected from the group consisting of zinc, manganese, and mixtures thereof, antimony containing component, and a phosphorus containing component. Typically, the metal containing component is zinc acetate or manganese acetate, the antimony containing component is antimony trioxide, and the phosphorus containing component is phosphoric acid. Preferably, the metal containing component is zinc acetate and is present in an amount from about 10 to about 200 ppm, the antimony trioxide is present in an amount from about 20 to about 500 ppm, and the phosphoric acid is present in an amount from about 5 to about 200 ppm.

The reaction mixture optionally includes one or more components selected from the group consisting of an iron containing compound, a toner, a cobalt containing compound, and mixtures thereof. For example, the reaction mixture and the polyester compositions of the invention may contain black iron oxide in an amount ranging from 1 ppm to 50 ppm, or 1 ppm to 10 ppm.

In another embodiment of the present invention, a method of incorporating a UV inhibitor in a polyester composition with or without a titanium containing ester exchange catalyst is provided. The method of this embodiment comprises forming a reaction mixture comprising a diol, a diacid component selected from the group consisting of dicarboxylic acids, dicarboxylic acid derivatives, and mixtures thereof in a polycondensation reaction system. The polycondensation reaction system comprises a series of reaction chambers. For purposes of differentiating each of the reaction chambers, each chamber may be assigned a label RCⁱ. Accordingly, each chamber is designatable as reaction chamber RC^{l}. The polycondensation system has a first reaction chamber designatable as reaction chamber RC^{l}, a last reaction chamber designatable as reaction chamber RC^{k}, and one or more intermediate reaction chambers. As used herein, i and k are integers, and k is the total number of reaction chambers. The polycondensation system is operated in series such that a reaction product designatable as product Pⁱ from reaction chamber RCⁱ is transportable to reaction chamber RCⁱ⁺¹ by a conduit designatable as conduit Cⁱ connecting reaction chamber RC^{l} to a reaction chamber RCⁱ⁺¹ (i.e., the polymerization product from each reaction chamber is transported to the next reaction chamber in the series.) Accordingly, the reaction mixture is successively polymerized as it proceeds through the polycondensation system. Preferably, the UV inhibitor is added to reaction product p^{k-}2 while reaction product p^{k-}2 is transported between reaction chamber RC^{k-}2 and reaction chamber RC^{k-1} (i.e., the UV inhibitor is added in the conduit connecting third from the last to the second to the last reaction chamber.) The UV inhibitors, the diol, and the diacid component are the same as set forth above with the same amounts as set forth above. The UV inhibitor may be added neat or in a carrier such as the same or different diol used in RC^{l}. By feeding the UV inhibitor into the conduit, it is possible to increase the yield of the UV inhibitor in the polyester composition. Without being bound to a theory, it is believed that by feeding the UV inhibitor into the conduit, the UV inhibitor has a sufficient residence time to dissolve into the melt, or absorded onto the polymer, or otherwise remain in the melt in contrast with adding the UV inhibitor to reaction chamber which typically operates under conditions promoting loss of the UV inhibitor as it is carried off with the flashing of the diol. In this embodiment, the reaction is preferably conducted in the presence of 0.0 to 5 ppm titanium containing ester exchange catalysts, more preferably using 0.0 ppm titanium containing compounds.

In yet another embodiment of the present invention, a titanium free polyester composition is provided. Preferably, the polyester composition is made by any one of the methods of the invention. The titanium free polyester composition of this embodiment comprises a diol residue, as diacid residue, a UV inhibitor residue, antimony atoms present in an amount of less than 0.1%; phosphorus atoms present in an amount of less than about 0.1%; metal atoms selected from the group consisting of zinc, manganese, and mixtures thereof in an amount from about 5 ppm to about 300 ppm; and titanium atoms present in an amount ranging from 0.0 to 5 ppm. By a titanium free polyester composition is meant one which contains from 0.0 to 5 ppm titanium metal. The UV inhibitor residue is the residue of the UV inhibitor set forth above. More preferably, the antimony atoms are present in an amount from about 20 to about 500 ppm and the phosphorus atoms are present in an amount from about 10 to about 200 ppm and the composition contains 2 ppm, most preferably 0.0 ppm titanium metal.

The diacid residue is preferably selected from the group consisting of dicarboxylic acid residues, dicarboxylic acid derivative residues, and mixtures thereof. More preferably, the diacid residue is a dicarboxylic acid ester residue. Most preferably, the diacid residue is a dimethyl terephthalate residue. The diol residue is preferably a glycol residue. The diol residue is selected from the group consisting of ethylene glycol residue, diethylene glycol residue, 1,4-cyclohexanedimethanol residue, and mixtures thereof. The ratio of the diol residues to the diacid residues is from about 0.5 to about 4. Moreover, the polyester composition of the present invention has less than about 20 meq/g of carboxyl ends.

The following examples illustrate the various embodiments of the present invention. Those skilled in the art will recognize many variations that are within the spirit of the present invention and scope of the claims.

### EXAMPLE

Dimethyl terephthalate (“DMT”), ethylene glycol (“EG”), 1,4-cyclohexanedimethanol (“CHDM”) 65 ppm zinc acetate, 230 ppm antimony trioxide, 70 ppm phosphoric acid, are introduced into the first reaction chamber of a multi-chamber polycondensation reactor at a pressure of about 48 psi. The DMT is fed into the first reaction chamber at a rate of 180 lb/min, the EG is fed into the first reaction chamber at a rate of about 130 lb/min EG, and the CHDM is fed into the first reaction chamber at a rate of about 2.2 lb/min. The zinc acetate is present in an amount of about 65 ppm zinc atoms, antimony trioxide is present in an amount of about 230 ppm antimony atoms, and the phosphoric acid is present in an amount of about 70 ppm phosphorus atoms (the amounts of these ingredients are determined by measuring the amount of metal atom present.) The polymerization product is transported from reactor to reactor with the reaction pressure decreasing in each subsequent reactor chamber. The temperatures of each reaction chamber was from about 200° C. to about 300° C. About 4 ppm of a blue toner, 2 ppm of a red toner, and 3.5 Fe₃O₄ are introduced into one of the intermediate reaction chambers. During transport of the polymerization product from the third to the last reaction chamber to the second to the last reaction chamber, about 475 ppm of the UV inhibitor with formula II is introduced. The final reaction chamber in the multichamber polycondensaion reactor is about 0.5 mm Hg. The resulting polyester removed from the last reactor is found to have about 95% of the UV inhibitor present.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A method of incorporating a UV inhibitor into a polyester resin, the method comprising:
a) forming a reaction mixture substantially free of a titanium containing ester exchange catalyst compound and comprising:
a diol,
a diacid component selected from the group consisting of dicarboxylic acids, dicarboxylic acid derivatives, and mixtures thereof,
an antimony containing compound in an amount of less than 0.1% of the total weight of the reaction mixture,
a phosphorus containing compound present in an amount of less than about 0.1% of the total weight of the reaction mixture,
a metal containing compound selected from the group consisting of zinc containing compounds, manganese containing compounds, present in an amount from about 10 ppm to about 300 ppm, and
a UV inhibitor having formula I: 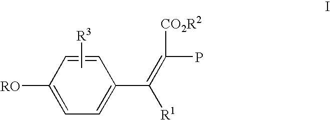
wherein,
R is hydrogen, alkyl, substituted alkyl, aryl, substituted aryl, cycloalkyl, substituted cycloalkyl, or alkenyl;
R¹ is hydrogen, or alkyl, aryl, or cycloalkyl, all of which may be substituted;
R² is hydrogen or any radical which does not interfere with condensation with the polyester;
R³ is hydrogen or 1-3 substituents selected from alkyl, substituted alkyl, alkoxy, substituted alkoxy, and halogen;
P is cyano or a group selected from carbamyl, aryl, alkylsulfonyl, arylsulfonyl, heterocyclic, alkanoyl or aroyl, all of which groups may be substituted; and
b) polymerizing the reaction mixture in a polycondensation reaction system, the polycondensation reaction system having a first reaction chamber, a last reaction chamber, and one or more intermediate reaction chambers between the first reaction chamber and the last reaction chamber, wherein the reaction system is operated in series such that the reaction mixture is progressively polymerized in the first reaction chamber, the one or more intermediate reactions, and the last reaction chamber.

2. The method of claim 1 wherein:
R² is hydrogen, alkyl, aralkyl, cycloalkyl, cyanoalkyl, aryl, alkoxyalkyl or hydroxyalkyl;
R is selected from hydrogen; cycloalkyl; cycloalkyl substituted with one or two of alkyl, alkoxy or halogen; phenyl; phenyl substituted with 1-3 of alkyl, alkoxy, halogen, alkanoylamino, or cyano; straight or branched lower alkenyl; straight or branched alkyl and such alkyl substituted with 1-3 of the following: halogen; cyano; succinimido; glutarimido; phthalimido; phthalimidino; 2-pyrrolidono; cyclohexyl; phenyl; phenyl substituted with alkyl, alkoxy, halogen, cyano, or alkylsulfamoyl; vinylsulfonyl; acrylamido; sulfamyl; benzoylsulfonicimido; alkylsulfonamido; phenylsulfonamido; alkenylcarbonylamino; groups of the formula 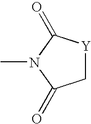
wherein Y is —NH—, 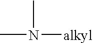
—O—, —S—, or —CH₂O—; —S—R⁴; SO₂CH₂CH₂SR⁴; wherein R⁴ is alkyl, phenyl, phenyl substituted with halogen, alkyl, alkoxy, alkanoylamino, or cyano, pyridyl, pyrimidinyl, benzoxazolyl, benzimidazolyl, benzothiazolyl, or a radical of the formulae 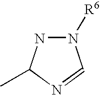
—NHXR⁵; —CONR⁶R⁶; and —SO₂NR⁶R⁶; wherein R⁶ is selected from H, aryl, alkyl, and alkyl substituted with halogen, phenoxy, aryl, —CN, cycloalkyl, alkylsulfonyl, alkylthio, or alkoxy; X is —CO—, —COO—, or —SO₂—; R⁵ is selected from alkyl and alkyl substituted with halogen, phenoxy, aryl, cyano, cycloalkyl, alkylsulfonyl, alkylthio, and alkoxy; and when X is —CO—, R⁵ also can be hydrogen, amino, alkenyl, alkylamino, dialkylamino, arylamino, aryl, or furyl; alkoxy; alkoxy substituted with cyano or alkoxy; phenoxy; or phenoxy substituted with 1-3 of alkyl, alkoxy, or halogen; and
P is cyano, carbamyl, N-alkylcarbamyl, N-alkyl-N-arylcarbamyl, N,N-dialkylcarbamyl, N,N-alkyl-arylcarbamyl, N-arylcarbamyl, N-cyclohexylcarbamyl, aryl, 2-benzoxazolyl, 2-benzothiazolyl, 2-benzimidazolyl, 1,3,4-thiadiazol-2-yl, 1,3,4-oxadiazol-2-yl, alkylsulfonyl, arylsulfonyl, alkanoyl or aroyl.

3. The method of claim 1 wherein R¹ is hydrogen.

4. The method of claim 1 wherein P is cyano.

5. The method of claim 1 wherein R¹ is hydrogen and P is cyano.

6. The method of claim 1 wherein the UV inhibitor is a compound having formula II:

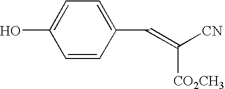

7. The method of claim 1 wherein the reaction mixture contains from 0.0 to 2 ppm titanium metal.

8. The method of claim 1 wherein the polymerization with each reaction chamber having a reaction pressure such that the reaction pressure in the first chamber is from about 20 to 50 psi and the reaction pressure in the last reaction chamber is from about 0.1 mm Hg to about 2 mm Hg with the reaction pressure in each of the one or more intermediate reactor being between 50 psi and 0.1 mm Hg.

9. The method of claim 1 wherein the reaction mixture contains 0.0 ppm titanium metal.

10. The method of claim 1 wherein the diol component is selected from the group consisting of ethylene glycol, 1,4-cyclohexanedimethanol, 1,2-propanediol, 1,3-propanediol, 1,4-butanediol, 2,2-dimethyl-1,3-propanediol, 1,6-hexanediol, 1,2-cyclohexanediol, 1,4-cyclohexanediol, 1,2-cyclohexanedimethanol, 1,3-cyclohexanedimethanol, X, 8-bis(hydroxymethyl)tricyclo-[5.2.1.0]-decane wherein X represents 3, 4, or 5; diols containing one or more oxygen atoms in a chain and mixtures thereof.

11. The method of claim 1 wherein the diacid component comprises a component selected from the groups consisting of terephthalic acid, isophthalic acid, naphthalene dicarboxylic acid, 1,4-cyclohexanedicarboxylic acid, 1,3-cyclohexanedicarboxylic acid, succinic acid, glutaric acid, adipic acid, sebacic acid, 1,12-dodecanedioic acid, and esters thereof; and mixtures thereof.

12. The method of claim 11 wherein the diacid component comprises dimethyl terephthalate.

13. The method of claim 11 wherein the molar ratio of the diol component to the diacid component is from about 0.5 to about 4.

14. The method of claim 1 wherein the reaction mixture further comprises a component containing a metal selected from the group consisting of zinc, manganese, and mixtures thereof, an antimony containing component, and a phosphorus containing component.

15. The method of claim 14 wherein the metal containing component is zinc acetate or manganese acetate, the antimony containing component is antimony trioxide, and the phosphorus containing component is phosphoric acid.

16. The method of claim 15 wherein the metal containing component is zinc acetate present in an amount from about 10 to about 200 ppm.

17. The method of claim 15 wherein the antimony trioxide is present in an amount from about 20 to about 500 ppm.

18. The method of claim 15 wherein the phosphoric acid is present in an amount from about 5 to about 200 ppm.

19. The method of claim 14 wherein one or more components selected from the group consisting of an iron containing compound, a toner, a cobalt containing compound, and mixtures thereof.

20. A method of incorporating a UV inhibitor into a polyester resin, the method comprising:
a) forming a reaction mixture comprising:
a diol,
a diacid component selected from the group consisting of dicarboxylic acids, dicarboxylic acid derivatives, and mixtures thereof in a polycondensation reaction system comprising a series of reaction chambers designatable as reaction chamber RCⁱ having a first reaction chamber designatable as reaction chamber RC^{l}, a last reaction chamber designatable as reaction chamber RC^{k}, and one or more intermediate reaction chambers
b) successively polymerizing the reaction mixture in the multichamber polymerization system wherein the reaction system is operated in series such that a reaction product designatable as product Pⁱ from reaction chamber Rⁱ is transportable to reaction chamber RCⁱ⁺¹ by a conduit designatable as conduit Cⁱ connecting reaction chamber RCⁱ to a reaction chamber RCⁱ⁺¹; and
c) adding the UV inhibitor to reaction product Pⁱ as it is transported from reaction chamber RCⁱ to reaction chamber RCⁱ⁺¹, wherein i and k are integer and k is the total number of reaction chambers.

21. The method of claim 20 wherein the UV inhibitor has formula I: 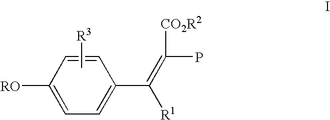
wherein,
R is hydrogen, alkyl, substituted alkyl, aryl, substituted aryl, cycloalkyl, substituted cycloalkyl, or alkenyl;
R¹ is hydrogen, or alkyl, aryl, or cycloalkyl, all of which may be substituted;
R² is hydrogen or any radical which does not interfere with condensation with the polyester;
R³ is hydrogen or 1-3 substituents selected from alkyl, substituted alkyl, alkoxy, substituted alkoxy, and halogen; and
P is cyano or a group selected from carbamyl, aryl, alkylsulfonyl, arylsulfonyl, heterocyclic, alkanoyl or aroyl, all of which groups may be substituted.

22. The method of claim 21 wherein:
R² is hydrogen, alkyl, aralkyl, cycloalkyl, cyanoalkyl, aryl, alkoxyalkyl or hydroxyalkyl;
R is selected from hydrogen; cycloalkyl; cycloalkyl substituted with one or two of alkyl, alkoxy or halogen; phenyl; phenyl substituted with 1-3 of alkyl, alkoxy, halogen, alkanoylamino, or cyano; straight or branched lower alkenyl; straight or branched alkyl and such alkyl substituted with 1-3 of the following: halogen; cyano; succinimido; glutarimido; phthalimido; phthalimidino; 2-pyrrolidono; cyclohexyl; phenyl; phenyl substituted with alkyl, alkoxy, halogen, cyano, or alkylsulfamoyl; vinylsulfonyl; acrylamido; sulfamyl; benzoylsulfonicimido; alkylsulfonamido; phenylsulfonamido; alkenylcarbonylamino; groups of the formula 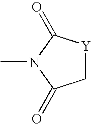
wherein Y is —NH—, 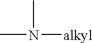
—O—, —S—, or —CH₂O—; —S—R4; SO₂CH₂CH₂SR⁴; wherein R⁴ is alkyl, phenyl, phenyl substituted with halogen, alkyl, alkoxy, alkanoylamino, or cyano, pyridyl, pyrimidinyl, benzoxazolyl, benzimidazolyl, benzothiazolyl, or a radical of the formulae 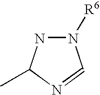
—NHXR⁵; —CONR⁶R⁶; and —SO₂NR⁶R⁶; wherein R⁶ is selected from H, aryl, alkyl, and alkyl substituted with halogen, phenoxy, aryl, —CN, cycloalkyl, alkylsulfonyl, alkylthio, or alkoxy; X is —CO—, —COO—, or —SO₂—; R⁵ is selected from alkyl and alkyl substituted with halogen, phenoxy, aryl, cyano, cycloalkyl, alkylsulfonyl, alkylthio, and alkoxy; and when X is —CO—, R⁵ also can be hydrogen, amino, alkenyl, alkylamino, dialkylamino, arylamino, aryl, or furyl; alkoxy; alkoxy substituted with cyano or alkoxy; phenoxy; or phenoxy substituted with 1-3 of alkyl, alkoxy, or halogen; and
P is cyano, carbamyl, N-alkylcarbamyl, N-alkyl-N-arylcarbamyl, N,N-dialkylcarbamyl, N,N-alkyl-arylcarbamyl, N-arylcarbamyl, N-cyclohexylcarbamyl, aryl, 2-benzoxazolyl, 2-benzothiazolyl, 2-benzimidazolyl, 1,3,4-thiadiazol-2-yl, 1,3,4-oxadiazol-2-yl, alkylsulfonyl, arylsulfonyl, alkanoyl or aroyl.

23. The method of claim 20 wherein R¹ is hydrogen.

24. The method of claim 20 wherein P is cyano.

25. The method of claim 20 wherein R¹ is hydrogen and P is cyano.

26. The method of claim 20 wherein the UV inhibitor is a compound having formula II:

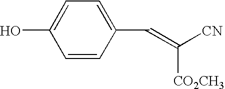

27. The method of claim 20 wherein the UV inhibitor added to reaction product p^{k-2} while reaction product P^{k-2} is transported between reaction chamber RC^{k-2} and reaction chamber RC^{k-1}.

28. The method of claim 20 wherein the reaction mixture contains from 0.0 to 2 ppm titanium containing compounds.

29. The method of claim 20 wherein the diol component is selected from the group consisting of ethylene glycol, 1,4-cyclohexanedimethanol, 1,2-propanediol, 1,3-propanediol, 1,4-butanediol, 2,2-dimethyl-1,3-propanediol, 1,6-hexanediol, 1,2-cyclohexanediol, 1,4-cyclohexanediol, 1,2-cyclohexanedimethanol, 1,3-cyclohexanedimethanol, X,8-bis(hydroxymethyl)tricyclo-[5.2.1.0]-decane wherein X represents 3, 4, or 5; diols containing one or more oxygen atoms in the chain and mixtures thereof.

30. The method of claim 20 wherein the diacid component comprises a component selected from the groups consisting of terephthalic acid, isophthalic acid, naphthalene dicarboxylic acid, 1,4-cyclohexanedicarboxylic acid, 1,3-cyclohexanedicarboxylic acid, succinic acid, glutaric acid, adipic acid, sebacic acid, 1,12-dodecanedioic acid, and esters thereof, and mixtures thereof.

31. The method of claim 30 wherein the diacid component comprises dimethyl terephthalate.

32. The method of claim 30 wherein the molar ratio of the diol component to the diacid component is from about 0.5 to about 4.

33. The method of claim 20 wherein the reaction mixture further comprises a component containing a metal selected from the group consisting of zinc, manganese, and mixtures thereof, an antimony containing component, and a phosphorus containing component.

34. The method of claim 33 wherein the metal containing component is zinc acetate or manganese acetate, the antimony containing component is antimony trioxide, and the phosphorus containing component is phosphoric acid.

35. The method of claim 34 wherein the metal containing component is zinc acetate present in an amount from about 10 to about 200 ppm.

36. The method of claim 34 wherein the antimony trioxide is present in an amount from about 20 to about 500 ppm.

37. The method of claim 33 wherein the phosphoric acid is present in an amount from about 5 to about 200 ppm.

38. The method of claim 33 wherein one or more components selected from the group consisting an iron containing compound, a toner, a cobalt containing compound, and mixtures thereof.

39. The method of claim 20, wherein the reaction mixture contains 0.0 ppm titanium metal.

40. A polyester composition comprising:
diacid residues;
diol residues;
UV inhibitor residues from a UV inhibitor having formula I: 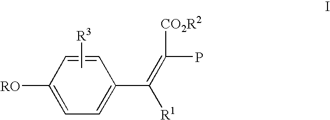
antimony atoms present in an amount of less than 0.1%;
phosphorus atoms present in an amount of less than about 0.1%;
metal atoms selected from the group consisting of zinc, manganese, and mixtures thereof in an amount from about 10 ppm to about 300 ppm; and
titanium atoms present in an amount of 0.0 to 5 ppm, wherein,
R is hydrogen, alkyl, substituted alkyl, aryl, substituted aryl, cycloalkyl, substituted cycloalkyl, or alkenyl;
R¹ is hydrogen, or alkyl, aryl, or cycloalkyl, all of which may be substituted;
R² is hydrogen or any radical which does not interfere with condensation with the polyester;
R³ is hydrogen or 1-3 substituents selected from alkyl, substituted alkyl, alkoxy, substituted alkoxy, and halogen; and
P is cyano or a group selected from carbamyl, aryl, alkylsulfonyl, arylsulfonyl, heterocyclic, alkanoyl or aroyl, all of which groups may be substituted.

41. The polyester composition of claim 40 wherein:
R² is hydrogen, alkyl, aralkyl, cycloalkyl, cyanoalkyl, aryl, alkoxyalkyl or hydroxyalkyl;
R is selected from hydrogen; cycloalkyl; cycloalkyl substituted with one or two of alkyl, alkoxy or halogen; phenyl; phenyl substituted with 1-3 of alkyl, alkoxy, halogen, alkanoylamino, or cyano; straight or branched lower alkenyl; straight or branched alkyl and such alkyl substituted with 1-3 of the following: halogen; cyano; succinimido; glutarimido; phthalimido; phthalimidino; 2-pyrrolidono; cyclohexyl; phenyl; phenyl substituted with alkyl, alkoxy, halogen, cyano, or alkylsulfamoyl; vinylsulfonyl; acrylamido; sulfamyl; benzoylsulfonicimido; alkylsulfonamido; phenylsulfonamido; alkenylcarbonylamino; groups of the formula 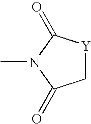
wherein Y is —NH—, 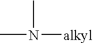
—O—, —S—, or —CH₂O—; —S—R⁴; SO₂CH₂CH₂SR⁴; wherein R⁴ is alkyl, phenyl, phenyl substituted with halogen, alkyl, alkoxy, alkanoylamino, or cyano, pyridyl, pyrimidinyl, benzoxazolyl, benzimidazolyl, benzothiazolyl, or a radical of the formulae 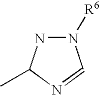
—NHXR⁵; —CONR⁶R⁶; and —SO₂NR⁶R⁶; wherein R⁶ is selected from H, aryl, alkyl, and alkyl substituted with halogen, phenoxy, aryl, —CN, cycloalkyl, alkylsulfonyl, alkylthio, or alkoxy; X is —CO—, —COO—, or —SO₂—; R⁵ is selected from alkyl and alkyl substituted with halogen, phenoxy, aryl, cyano, cycloalkyl, alkylsulfonyl, alkylthio, and alkoxy; and when X is —CO—, R⁵ also can be hydrogen, amino, alkenyl, alkylamino, dialkylamino, arylamino, aryl, or furyl; alkoxy; alkoxy substituted with cyano or alkoxy, phenoxy; or phenoxy substituted with 1-3 of alkyl, alkoxy, or halogen; and
P is cyano, carbamyl, N-alkylcarbamyl, N-alkyl-N-arylcarbamyl, N,N-dialkylcarbamyl, N,N-alkyl-arylcarbamyl, N-arylcarbamyl, N-cyclohexylcarbamyl, aryl, 2-benzoxazolyl, 2-benzothiazolyl, 2-benzimidazolyl, 1,3,4-thiadiazol-2-yl, 1,3,4-oxadiazol-2-yl, alkylsulfonyl, arylsulfonyl, alkanoyl or aroyl.

42. The polyester composition of claim 40 wherein R¹ is hydrogen.

43. The polyester composition of claim 40 wherein P is cyano.

44. The polyester composition of claim 40 wherein R¹ is hydrogen and P is cyano.

45. The polyester composition of claim 40 wherein the UV inhibitor is a compound having formula II:

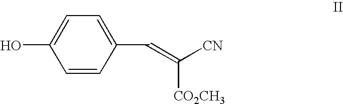

46. The polyester composition of claim 40 wherein the diacid residue is selected from the group consisting of dicarboxylic acid residues, dicarboxylic acid derivative residues, and mixtures thereof.

47. The polyester composition of claim 40 wherein the diacid residue is a dicarboxylic acid ester residue.

48. The polyester composition of claim 46 wherein the diacid residue is a dimethyl terephthalate residue.

49. The polyester composition of claim 40 wherein the diol residue is a glycol.

50. The polyester composition of claim 40 wherein the diol residue is selected from the group consisting of residues of ethylene glycol, 1,4-cyclohexanedimethanol, 1,2-propanediol, 1,3-propanediol, 1,4-butanediol, 2,2-dimethyl-1,3-propanediol, 1,6-hexanediol, 1,2-cyclohexanediol, 1,4-cyclohexanediol, 1,2-cyclohexanedimethanol, 1,3-cyclohexanedimethanol, X, 8-bis(hydroxymethyl)tricyclo-[5.2.1.0]-decane wherein X represents 3, 4, or 5; diols containing one or more oxygen atoms in the chain and mixtures thereof.

51. The polyester composition of claim 40 wherein the diacid residue comprises a component selected from the groups consisting of residues of terephthalic acid, naphthalene dicarboxylic acid, isophthalic acid, 1,4-cyclohexanedicarboxylic acid, 1,3-cyclohexanedicarboxylic acid, succinic acid, glutaric acid, adipic acid, sebacic acid, 1,12-dodecanedioic acid, and esters thereof, and mixtures thereof.

52. The polyester composition of claim 40 wherein the molar ratio of the diol residues to the diacid residues is from about 0.5 to about 4.

53. The polyester composition of claim 40 having less than about 20 meq/g of carboxyl ends.

54. The polyester composition of claim 40 wherein the antimony atoms are present in an amount from about 20 to about 500 ppm.

55. The polyester composition of claim 40 wherein the phosphorus atoms are present in an amount from about 10 to about 200 ppm.

56. The polyester composition of claim 40, wherein the amount of titanium metal is 0.0 ppm.

57. The polyester composition of claim 40, further comprising black iron oxide.

58. The polyester composition of claim 57, wherein the amount of black iron oxide ranges from 1 ppm to 10 ppm.
